(19) United States
(12) Patent Application Publication
(10) Pub. No.: US 2017/0274482 A1
(43) Pub. Date: Sep. 28, 2017

(54) FLUX-CORED WIRE FOR GAS-SHIELDED ARC WELDING

(71) Applicant: Kabushiki Kaisha Kobe Seiko Sho (Kobe Steel, Ltd.), Kobe-shi (JP)

(72) Inventors: Peng HAN, Fujisawa-shi (JP); Hiroyuki KAWASAKI, Fujisawa-shi (JP); Yoshihiko KITAGAWA, Fujisawa-shi (JP); Hidenori NAKO, Shinagawa-ku (JP); Takuya KOCHI, Kobe-shi (JP); Wataru URUSHIHARA, Nagoya-shi (JP); Yoshitomi OKAZAKI, Kobe-shi (JP)

(73) Assignee: Kabushiki Kaisha Kobe Seiko Sho (Kobe Steel, Ltd.), Kobe-shi (JP)

(21) Appl. No.: 15/505,288

(22) PCT Filed: Sep. 2, 2015
(86) PCT No.: PCT/JP2015/074933

§ 371 Date: Feb. 21, 2017

(30) Foreign Application Priority Data
Sep. 3, 2014 (JP) 2014-178915

(51) Int. Cl. B23K 35/368; B23K 35/30

(52) U.S. Cl. CPC B23K 35/368; B23K 35/3073; B23K 9/173

(57) ABSTRACT

A flux cored wire, which is obtained by filling the inside of a steel outer skin with a flux, is configured to have a composition that contains, in mass % relative to the total mass of the wire, 0.01-0.12% of C, 0.05% or more but less than 0.30% of Si, 1.0-3.5% of Mn, 0.1% or more but less than 1.0% of Ni, 0.10-0.30% of Mo, 0.1-0.9% of Cr, 4.5-8.5% of TiO₂, 0.10-0.40% of SiO₂, 0.03-0.23% of Al₂O₃ and 80% or more of Fe.

### TECHNICAL FIELD

The present invention relates to a flux-cored wire for gas-shielded arc welding. More specifically, the present invention relates to a flux-cored wire for gas-shielded arc welding used for welding of steels with a tensile strength of about 490 to 670 MPa.

### BACKGROUND ART

Various studies have been conducted on flux-cored wires used when steels with a tensile strength of about 490 to 670 MPa are subjected to gas-shielded arc welding for the purposes of improving welding workability and improving the mechanical properties of weld metals (e.g., refer to PTL 1 and PTL 2).

PTL 1 proposes a flux-cored wire for gas-shielded arc welding in which the wire composition is specified in order to improve all-position welding workability and obtain weld metals having high strength and low-temperature toughness in the as-welded (AW) and post-weld heat-treated (PWHT) conditions. The flux-cored wire described in PTL 1 has a composition that contains, in particular amounts, C, Si, Mn, Ni, B, Mg, V, Ti oxide, metal Ti, Al oxide, metal Al, Si oxide, and metal fluoride and also contains P and Nb in amounts controlled so as to be smaller than or equal to particular amounts, the balance being Fe of a steel sheath, iron powder, an Fe component in iron alloy powder, an arc stabilizer, and incidental impurities.

PTL 2 proposes a flux-cored wire for high tensile steel in which the wire and flux compositions are specified in order to achieve high-efficient all-position welding and obtain weld metals having good cracking resistance and high low-temperature toughness in welding of high tensile steels with a proof stress of 690 MPa or more. Specifically, the flux-cored wire described in PTL 2 has a composition that contains C, Si, Mn, Ni, and Al as essential elements in particular amounts and at least one of Cr, Mo, Nb, and V as a selective element, in a particular amount, and also contains TiO₂, SiO₂, ZrO₂, Al₂O₃, and a fluorine compound in a flux in particular amounts, the balance being Fe, an arc stabilizer, and incidental impurities. Furthermore, the total hydrogen content in the flux-cored wire is 15 ppm or less.

### CITATION LIST

### Patent Literature

PTL 1: Japanese Unexamined Patent Application Publication No. 2012-121051

PTL 2: Japanese Unexamined Patent Application Publication No. 2010-274304

### SUMMARY OF INVENTION

### Technical Problem

In the development of petroleum and gas and the transport of oil and gas, sour corrosion such as sulfide stress corrosion cracking (SSCC) or hydrogen embrittlement occurs. To address this problem, the Ni content in a weld metal is controlled to 1 mass % or less in the standard (NACE MR0175) of National Association of Corrosion Engineers (NACE).

However, the flux-cored wire in PTL 1 contains 0.1 to 3.0 mass % of Ni to achieve high low-temperature toughness, and thus the Ni content in a weld metal sometimes exceeds 1 mass %. Therefore, the flux-cored wire does not sufficiently meet the requirement of NACE. In the flux-cored wire in PTL 1, studies are not conducted on heat treatment conditions. Therefore, it is unclear whether a weld metal having high proof stress, strength, and low-temperature toughness is obtained even when heat treatment is performed under severer conditions.

The flux-cored wire described in Cited Document 2 also contains 1.0 to 3.0 mass % of Ni and thus does not meet, the requirement of NACE. In this flux-cored wire, studies are not conducted on the performance of a weld metal after heat treatment. As in the flux-cored wire in Cited Document 1, it is unclear whether a weld metal having high strength and low-temperature toughness is obtained even when heat treatment is performed under severe conditions.

Accordingly, it is a main object of the present invention to provide a flux-cored wire for gas-shielded arc welding which achieves good welding workability and with which a weld metal having high low-temperature toughness is obtained in both as-welded and heat-treated conditions even when the Ni content is 1 mass % or less.

### Solution to Problem

A flux-cored wire for gas-shielded arc welding according to the present invention is obtained by filling a steel sheath with a flux and contains, relative to a total mass of the wire, C: 0.01 to 0.12 mass %, Si: 0.05 mass % or more and less than 0.30 mass %, Mn: 1.0 to 3.5 mass %, Ni: 0.1 mass % or more and less than 1.0 mass %, Mo: 0.10 to 0.30 mass %, Cr: 0.1 to 0.9 mass %, TiO₂: 4.5 to 8.5 mass %, SiO₂: 0.10 to 0.40 mass %, Al₂O₃: 0.03 to 0.23 mass %, and Fe: 80 mass % or more.

In the flux-cored wire, a V content may be controlled to 0.020 mass % or less relative to the total mass of the wire.

A C content (mass %) [C], a Mn content (mass %) [Mn], a Si content (mass %) [Si], a Mo content (mass %) [Mo], and a Cr content (mass %) [Cr] relative to the total mass of the wire may satisfy mathematical formula (A) below.

$$\begin{matrix}[ Math . 1 ] & \\ 1.6 ≦ \frac{10 \times [ C ] + [ Mn ]}{[ Si ] + [ Mo ] + [ Cr ]} ≦ 5.6 & ( A )\end{matrix}$$

The flux-cored wire for gas-shielded arc welding according to the present invention may further contain 0.2 to 0.7 mass % of Mg relative to the total mass of the wire.

The flux-cored wire for gas-shielded arc welding according to the present invention may further contain 0.05 to 0.30 mass % of Ti relative to the total mass of the wire.

The flux-cored wire for gas-shielded arc welding according to the present invention may further contain 0.05 to 0.30 mass % of a metal fluoride in terms of F relative to the total mass of the wire.

The flux-cored wire for gas-shielded arc welding according to the present invention may further contain 0.01 to 0.30 mass % in total of at least one of a Na compound and a K compound in terms of Na and K relative to the total mass of the wire.

The flux-cored wire for gas-shielded arc welding according to the present invention may further contain 0.001 to 0.020 mass % in total of at least one of B, a B alloy, and a B oxide in terms of B relative to the total mass of the wire.

In the flux-cored wire, a ZrO₂ content may be controlled to less than 0.02 mass % relative to the total mass of the wire.

### Advantageous Effects of Invention

According to the present invention, good welding workability is achieved and a weld metal having high low-temperature toughness is obtained in both as-welded and heat-treated conditions even when the Ni content is 1 mass % or less.

### BRIEF DESCRIPTION OF DRAWINGS

FIG. 1 illustrates an influence of the relationship between the C and Mn contents and the Si, Mo, and Cr contents on the mechanical properties of weld metals.

### DESCRIPTION OF EMBODIMENTS

Hereafter, embodiments of the present invention will be described in detail. The present invention is not limited to the embodiments described below.

A flux-cored wire according to this embodiment is obtained by filling a steel sheath with a flux and is used for gas-shielded arc welding. The flux-cored wire according to this embodiment contains, relative to the total mass of the wire, 0.01 to 0.12 mass % of C, 0.05 mass % or more and less than 0.30 mass % of Si, 1.0 to 3.5 mass % of Mn, 0.1 mass % or more and less than 1.0 mass % of Ni, 0.10 to 0.30 mass % of Mo, 0.1 to 0.9 mass % of Cr, 4.5 to 8.5 mass % of TiO₂, 0.10 to 0.40 mass % of SiO₂, 0.03 to 0.23 mass % of Al₂O₃, and 80 mass % or more of Fe. Note that components other than the above components, that is, the balance in the flux-cored wire according to this embodiment is incidental impurities.

The flux-cored wire according to this embodiment may also contain, for example, Mg, Ti, a metal fluoride, a Na compound, a K compound, B, a B alloy, and a B oxide in addition to the above components. If the flux-cored wire according to this embodiment contains V and ZrO₂, their contents are preferably controlled.

In the flux-cored wire according to this embodiment, the relationship between the C and Mn contents and the Si, Mo, and Cr contents preferably satisfies mathematical formula (A) below. In the mathematical formula (A) below, [C] is a C content (mass %) relative to the total mass of the wire, [Mn] is a Mn content (mass %) relative to the total mass of the wire, [Si] is a Si content (mass %) relative to the total mass of the wire, [Mo] is a Mo content (mass %) relative to the total mass of the wire, and [Cr] is a Cr content (mass %).

$$\begin{matrix}[ Math . 2 ] & \\ 1.6 ≦ \frac{10 \times [ C ] + [ Mn ]}{[ Si ] + [ Mo ] + [ Cr ]} ≦ 5.6 & ( A )\end{matrix}$$

The content of each component described above can be measured by wet chemical analysis such as a volumetric method or a gravimetric method. For example, C can be measured by an infrared absorption method after combustion; Ti, Si, Zr, Mn, Al, Mg, Ni, Mo, Cr, and B can be measured by ICP emission spectrometry; Na and K can be measured by atomic absorption spectrometry; and F can be measured by neutralization titration.

The outer diameter of the flux-cored wire according to this embodiment is not particularly limited, and is generally 1.0 to 2.0 mm and preferably 1.2 to 1.6 mm in a practical manner. The flux filling ratio can be set to any value as long as the wire has a composition that satisfies the above ranges. From the viewpoint of wire drawability and welding workability (e.g., feedability), the flux filling ratio is preferably 10 to 30 mass % relative to the total mass of the wire. Furthermore, the flux-cored wire according to this embodiment may have any cross-sectional shape and any internal shape and may be a seamed wire or a seamless wire.

Hereafter, the reasons for placing numerical limitations on components contained in the flux-cored wire according to this embodiment will be described. The content of each component is a value relative to the total mass of the wire unless otherwise specified. The effects and the like described in the reasons for numerical limitations are effects and the like common to weld metals both in the as-welded and stress-relieved (SR) conditions unless otherwise specified.

### [C: 0.01 to 0.12 Mass %]

C is an element required to achieve high strength of weld metals in the as-welded and SR conditions. If the C content is less than 0.01 mass %, such weld metals have insufficient strength and an effect of stabilizing toughness is not sufficiently produced. If the C content is more than 0.12 mass %, the hot cracking resistance of weld metals degrades, and the strength of weld metals excessively increases, which degrades the low-temperature toughness. Therefore, the C content is 0.01 to 0.12 mass %.

The C content is preferably 0.03 mass % or more from the viewpoint of improving the strength and toughness of weld metals, and is preferably 0.10 mass % or less from the viewpoint of improving the hot cracking resistance and low-temperature toughness of weld metals. Note that C may be contained in a flux and/or a steel sheath. Examples of a C source in the flux-cored wire according to this embodiment include graphite and C accompanying Fe—Mn and Fe—Si added as flux components and C added to a steel sheath.

[Si: 0.05 Mass % or More and Less than 0.30 Mass %]

Si is also an element required to achieve high strength of weld metals in the as-welded and SR conditions. If the Si content is less than 0.05 mass %, the low-temperature toughness of weld metals degrades because of insufficient deoxidation. If the Si content is 0.30 mass % or more, the amount of Si is excessively increased, and Si is dissolved in ferrite, which increases the strength of matrix ferrite. Consequently, the low-temperature toughness of weld metals, in particular, weld metals after SR degrades. Therefore, the Si content is 0.05 mass % or more and less than 0.30 mass %.

The Si content is preferably 0.08 mass % or more from the viewpoint of increasing a deoxidation effect to improve the low-temperature toughness of weld metals, and is preferably 0.20 mass % or less from the viewpoint of improving the low-temperature toughness of weld metals after SR. Note that Si may be contained in a flux and/or a steel sheath. Examples of a Si source in the flux-cored wire according to this embodiment include Fe—Si and Si—Mn added as flux components and Si added to a steel sheath.

### [Mn: 1.0 to 3.5 Mass %]

Mn is an element that forms an oxide from which a microstructure is generated during welding and that is effective for improving the strength and toughness of weld metals. If the Mn content is less than 1.0 mass %, weld metals have insufficient strength and the toughness degrades. If the Mn content is more than 3.5 mass %, the strength and hardenability are excessively increased, which degrades the toughness of weld metals. Therefore, the Mn content is 1.0 to 3.5 mass %.

The Mn content is preferably 1.2 mass % or more from the viewpoint of improving the strength and toughness of weld metals, and is preferably 3.0 mass % or less from the viewpoint of adjusting the strength and hardenability of weld metals and improving the toughness. Note that Mn may be contained in a flux and/or a steel sheath. Examples of a Mn source in the flux-cored wire according to this embodiment include metal Mn, Fe—Mn, and Si—Mn added as flux components and Mn added to a steel sheath.

[Ni: 0.1 Mass % or More and Less than 1.0 Mass %]

In known flux-cored wires, the Ni content relative to the total mass of the wire has been set to 1 mass % or more because Ni is added to weld metals in such an amount that sufficient low-temperature toughness is achieved. However, if a large amount of Ni is contained in weld metals, the susceptibility to sulfide stress corrosion cracking (SSCC) increases in an H₂S environment. Therefore, in the flux-cored wire according to this embodiment, the Ni content is decreased to a value lower than the known Ni content to meet the NACE standard.

Specifically, the Ni content is 0.10 mass % or more and less than 1.0 mass %. If the Ni content is less than 0.10 mass %, an effect of improving the toughness of weld metals is not sufficiently produced. If the Ni content is 1.0 mass % or more, weld metals that meet the NACE standard are not obtained, and the hot cracking resistance of weld metals also degrades. The Ni content is preferably 0.30 mass % or more and more preferably 0.50 mass % or more from the viewpoint of improving the toughness of weld metals. To further improve the hot cracking resistance while meeting the NACE standard, the Ni content is preferably 0.95 mass % or less.

Note that Ni may be contained in a flux and/or a steel sheath. Examples of a Ni source in the flux-cored wire according to this embodiment include metal Ni and Ni—Mg added as flux components and Ni added to a steel sheath.

### [Mo: 0.10 to 0.30 Mass %]

Mo is an important element for the flux-cored wire according to this embodiment because Mo produces effects of suppressing the coarsening of intergranular carbides and the softening after annealing, and refining a microstructure. If the Mo content is less than 0.10 mass %, weld metals have insufficient strength. If the Mo content is more than 0.30 mass %, the transition temperature of brittle fracture shifts to high temperature, which degrades the toughness of weld metals. Therefore, the Mo content is 0.10 to 0.30 mass %.

The Mo content is preferably 0.15 mass % or more from the viewpoint of improving the strength of weld metals, and is preferably 0.25 mass % or less from the viewpoint of improving the toughness of weld metals. Note that Mo may be contained in a flux and/or a steel sheath. Examples of a Mo source in the flux-cored wire according to this embodiment include metal Mo and Fe—Mo added as flux components and Mo added to a steel sheath.

### [Cr: 0.1 to 0.9 Mass %]

Cr produces an effect of refining intergranular carbides generated during SR. If the Cr content is less than 0.1 mass %, weld metals have insufficient strength, and coarse intergranular carbides present in prior γ grain boundaries are not sufficiently refined, which degrades the toughness of weld metals after SR. If the Cr content is more than 0.9 mass %, the strength and hardenability of weld metals are excessively increased, which degrades the low-temperature toughness. Therefore, the Cr content is 0.1 to 0.9 mass %. The Cr content is preferably 0.2 mass % or more from the viewpoint of improving the strength of weld metals and the toughness of weld metals after SR.

Note that Cr may be contained in a flux and/or a steel sheath. Examples of a Cr source in the flux-cored wire according to this embodiment include metal Cr and Fe—Cr added as flux components and Cr added to a steel sheath.

### [TiO₂: 4.5 to 8.5 Mass %]

TiO₂ serves as an arc stabilizer and is also a main component of a slagging agent. If the TiO₂ content is less than 4.5 mass %, the welding workability degrades, which makes it difficult to perform all-position welding. If the TiO₂ content is more than 8.5 mass %, the amount of oxygen in a weld metal increases, which degrades the toughness. Therefore, the TiO₂ content is 4.5 to 8.5 mass %. The TiO₂ content is preferably 5.5 to 8.0 mass % from the viewpoint of improving the toughness of weld metals. Examples of a TiO₂ source in the flux-cored wire according to this embodiment include rutile and titanium oxide added as flux components.

### [SiO₂: 0.10 to 0.40 Mass %]

SiO₂ produces an effect of providing a good bead shape. If the SiO₂ content is less than 0.10 mass %, such an effect is not sufficiently produced, and the bead shape degrades. If the SiO₂ content is more than 0.40 mass %, the amount of spatters generated increases. Therefore, the SiO₂ content is 0.10 to 0.40 mass %. The SiO₂ content is preferably 0.15 mass % or more from the viewpoint of improving the bead shape, and is preferably 0.35 mass % or less from the viewpoint of suppressing generation of spatters. Examples of a SiO₂ source in the flux-cored wire according to this embodiment include silica, potash glass, and soda glass added as flux components.

[Al₂O₃: 0.03 to 0.23 Mass %]

Al₂O₃ also produces an effect of providing a good bead shape. If the Al₂O₃ content is less than 0.03 mass %, such an effect is not sufficiently produced, and the bead shape degrades. If the Al₂O₃ content is more than 0.23 mass %, the amount of spatters generated increases. Therefore, the Al₂O₃ content is 0.03 to 0.23 mass %. The Al₂O₃ content is preferably 0.07 mass % or more from the viewpoint of improving the bead shape, and is preferably 0.19 mass % or less from the viewpoint of suppressing generation of spatters. An Example of an Al₂O₃ source in the flux-cored wire according to this embodiment is alumina added as a flux component.

### [Fe: 80 Mass % or More]

For example, in the case of flux-cored wires for all-position welding, if the Fe content is less than 80 mass %, the amount of slag generated is excessively increased, and the bead shape degrades. The Fe content is preferably 82 to 93 mass % from the viewpoint of improving the bead shape. Examples of an Fe source in the flux-cored wire according to this embodiment include a steel sheath, and iron powder and an Fe alloy added to a flux.

### [(10×C+Mn)/(Si+Mo+Cr): 1.6 to 5.6]

In the flux-cored wire according to this embodiment, the relationship between the C content, the Mn content, the Si content, the Mo content, and the Cr content is also important in addition to the content of each component. When the wire composition is within the above range, the tensile strength and low-temperature toughness of weld metals and the welding workability can be improved to a certain level. Furthermore, the present inventors have found that when the relationship between the C content, the Mn content, the Si content, the Mo content, and the Cr content satisfies the above-described mathematical formula (A), the tensile strength and low-temperature toughness of weld metals and the welding workability can be further improved.

When (10×[C]+[Mn])/([Si]+[Mo]+[Cr]) is in the range of 1.6 to 5.6, the hardenability is improved, which increases the tensile strength of weld metals. In addition, since temper embrittlement due to incidental impurities such as P and S, precipitation hardening of fine carbides such as Mo₂C, and a decrease in AC1 transformation temperature can be suppressed, the low-temperature toughness of weld metals after SR is improved. Furthermore, generation of coarse carbides in prior γ grain boundaries is suppressed. Even if coarse carbides are generated in prior γ grain boundaries, they can be refined. Consequently, the tensile strength and low-temperature toughness of weld metals after SR can be improved. The viscosity of a molten pool can also be prevented from decreasing, and thus vertical welding workability is also improved.

If (10×[C]+[Mn])/([Si]+[Mo]+[Cr]) is less than 1.6, sufficient hardenability is not achieved, which may degrade the tensile strength of weld metals. Furthermore, the temper embrittlement due to incidental impurities such as P and S and the precipitation hardening of fine carbides such as Mo₂C are facilitated, which may degrade the low-temperature toughness of weld metals after SR. If (10×[C]+[Mn])/([Si]+[Mo]+[Cr]) is more than 5.6, the AC1 transformation temperature decreases and the generation of coarse carbides in prior γ grain boundaries is facilitated, which may degrade the low-temperature toughness of weld metals after SR. Furthermore, sufficient hardenability is not achieved, the viscosity in a molten pool decreases, and an effect of refining coarse carbides in prior γ grain boundaries decreases. Consequently, the vertical welding workability and the tensile strength and low-temperature toughness after SR may degrade.

### [V: 0.020 Mass % or Less]

V affects the low-temperature toughness of weld metals after SR, and thus the V content is preferably controlled to 0.020 mass % or less. This improves the low-temperature toughness of weld metals after SR.

[ZrO₂: Less than 0.02 Mass %]

If the wire excessively contains ZrO₂, the vertical welding workability may degrade. Therefore, the ZrO₂ content is preferably controlled to less than 0.02 mass %. This improves the welding workability. Examples of a ZrO₂ source in the flux-cored wire according to this embodiment include zircon sand and zirconia.

### [Mg: 0.2 to 0.7 Mass %]

Mg is a deoxidizing element and produces an effect of improving the toughness of weld metals, and therefore can be optionally added. If the Mg content is less than 0.2 mass %, a sufficient deoxidizing effect is not achieved and the toughness of weld metals is not improved as desired. If the Mg content is more than 0.7 mass %, the amount of spatters increases, which degrades the welding workability. Therefore, when Mg is added, the Mg content is set to 0.2 to 0.7 mass %. Examples of a Mg source in the flux-cored wire according to this embodiment include metal Mg, Al—Mg, and Ni—Mg.

### [Ti: 0.05 to 0.30 Mass %]

Ti also produces an effect of improving the toughness of weld metals and can be optionally added. If the Ti content is less than 0.05 mass %, nucleation does not sufficiently occur and the toughness of weld metals is not sufficiently improved. If the Ti content is more than 0.30 mass %, Ti is excessively dissolved, which excessively increases the strength of weld metals and also degrades the toughness. Therefore, when Ti is added to the flux-cored wire according to this embodiment, the Ti content is set to 0.05 to 0.30 mass %. This provides a weld metal having higher toughness.

Ti may be contained in a flux and/or a steel sheath. Examples of a Ti source in the flux-cored wire according to this embodiment include metal Ti and Fe—Ti added as flux components and Ti added to a steel sheath.

### [Metal Fluoride (in Terms of F): 0.05 to 0.30 Mass %]

A metal fluoride contributes to stabilizing an arc during welding and therefore can be optionally added. If the metal fluoride content in terms of F is less than 0.05 mass %, an effect of stabilizing an arc is small and the amount of spatters generated may increase. If the metal fluoride content in terms of F is more than 0.30 mass %, the bead shape degrades. Therefore, when a metal fluoride is added, the metal fluoride content in terms of F is set to 0.05 to 0.30 mass %.

### [Na Compound (in Terms of Na), K Compound (in Terms of K): 0.01 to 0.30 Mass % in Total]

At least one of a Na compound and a K compound can be optionally added to a flux as an arc stabilizer. If the total content of the Na compound and K compound is less than 0.01 mass % in terms of Na and K, respectively, an effect of stabilizing an arc is small and the amount of spatters generated may increase. If the total content of the Na compound and K compound is more than 0.30 mass % in terms of Na and K, respectively, the bead shape degrades. Therefore, when the Na compound and K compound are added, the total content of the Na compound and K compound is set to 0.01 to 0.30 mass % in terms of Na and K, respectively.

For example, sodium fluoride and potassium fluoride are used as a material for fluxes. In the case of potassium fluoride, the fluorine component is calculated in “the metal fluoride content” and the potassium component is calculated in “the Na compound content and the K compound content”.

### [At Least One of B, B Alloy (in Terms of B), and B Oxide (in Terms of B): 0.001 to 0.020 Mass % in Total]

At, least, one of B, B alloys, and B oxides can be optionally added to improve the toughness of weld metals. If the total content in terms of B is less than 0.001 mass %, an effect of improving the toughness of weld metals is small. If the total content is more than 0.020 mass %, the hot cracking resistance of weld metals degrades. Therefore, when B, B alloys, and B oxides are added to the flux-cored wire according to this embodiment, the total content is set to 0.001 to 0.020 mass % in terms of B. This provides a weld metal having higher toughness.

The total content of B, B alloys, and B oxides is preferably 0.003 mass % or more in terms of B from the viewpoint of improving the toughness of weld metals, and is preferably 0.015 mass % or less in terms of B from the viewpoint of the hot cracking resistance of weld metals. Examples of a B source in the flux-cored wire according to this embodiment include an Fe—B alloy, an Fe—Si—B alloy, and B₂O₃.

### [Balance]

The balance in the composition of the flux-cored wire according to this embodiment is incidental impurities. Examples of the incidental impurities in the flux-cored wire according to this embodiment include V, S, P, Cu, Sn, Na, Co, Ca, Nb, Li, Sb, and As. In addition to the above-described components, the flux-cored wire according to this embodiment may contain, for example, alloy elements other than the above elements, a slag forming agent, and an arc stabilizer as long as the advantageous effects of the present invention are not impaired. When the above-described elements are added in the form of an oxide and a nitride, the balance of the flux-cored wire according to this embodiment contains O and N.

In the flux-cored wire according to this embodiment, the wire components are specified. Therefore, even at a Ni content of 1 mass % or less, a weld metal having high low-temperature toughness is obtained in both the as-welded and heat-treated conditions. This further improves the safety of structures used in a low-temperature environment. In particular, a flux-cored wire which achieves good welding workability and with which a weld metal having high sour resistance and high low-temperature toughness is obtained can be provided in pipe welding for platforms and plants.

Furthermore, when the relationship between the C content, the Mn content, the Si content, the Mo content, and the Cr content satisfies the mathematical formula (A), the transition temperature of brittle fracture of weld metals can be shifted to low temperature and the generation of spatters can be suppressed. Consequently, both the low-temperature toughness and welding workability of weld metals can be further improved.

### EXAMPLES

Hereafter, the advantageous effects of the present invention will be specifically described based on Examples of the present invention and Comparative Examples. In Examples, a steel sheath made of mild steel was filled with 13 to 20 mass % of a flux to produce flux-cored wires in Examples and Comparative Examples having compositions shown in Tables 1 and 2 below. Herein, the wire diameter was 1.2 mm. The wire Nos. 1 to 13 in Table 1 below correspond to Examples, which are within the scope of the present invention. The wire Nos. 14 to 28 in Table 2 below correspond to Comparative Examples, which are outside the scope of the present invention.

TABLE 1

| | | Wire composition (mass %) | | | | | | | | | | |
|---|---|---|---|---|---|---|---|---|---|---|---|---|
| | | | | | | | | | | | | Metal fluoride |
| | No. | Fe | C | Mn | Si | Cr | Ni | Mo | TiO₂ | SiO₂ | Al₂O₃ | (in terms of F) |
| Example | 1 | 88 | 0.05 | 2.0 | 0.10 | 0.5 | 0.90 | 0.20 | 6.9 | 0.24 | 0.13 | 0.16 |
| | 2 | 86 | 0.12 | 3.0 | 0.05 | 0.6 | 0.85 | 0.10 | 8.2 | 0.10 | 0.05 | 0.20 |
| | 3 | 84 | 0.01 | 3.5 | 0.25 | 0.9 | 0.95 | 0.30 | 7.8 | 0.40 | 0.23 | 0.30 |
| | 4 | 91 | 0.07 | 1.5 | 0.20 | 0.1 | 0.70 | 0.25 | 5.4 | 0.17 | 0.03 | 0.05 |
| | 5 | 91 | 0.04 | 1.0 | 0.29 | 0.4 | 0.10 | 0.16 | 5.9 | 0.20 | 0.05 | 0.10 |
| | 6 | 86 | 0.11 | 2.0 | 0.11 | 0.7 | 0.99 | 0.18 | 8.5 | 0.10 | 0.07 | 0.06 |
| | 7 | 92 | 0.03 | 1.5 | 0.07 | 0.3 | 0.55 | 0.10 | 4.5 | 0.30 | 0.05 | 0.08 |
| | 8 | 90 | 0.07 | 2.7 | 0.20 | 0.2 | 0.65 | 0.18 | 5.3 | 0.17 | 0.03 | 0.05 |
| | 9 | 86 | 0.05 | 3.0 | 0.13 | 0.5 | 0.80 | 0.21 | 7.7 | 0.30 | 0.20 | 0.00 |
| | 10 | 89 | 0.01 | 1.0 | 0.28 | 0.8 | 0.90 | 0.20 | 6.5 | 0.20 | 0.15 | 0.10 |
| | 11 | 90 | 0.02 | 2.0 | 0.08 | 0.2 | 0.15 | 0.29 | 5.4 | 0.37 | 0.21 | 0.25 |
| | 12 | 91 | 0.05 | 1.8 | 0.10 | 0.8 | 0.40 | 0.27 | 5.0 | 0.23 | 0.09 | 0.06 |
| | 13 | 90 | 0.04 | 1.0 | 0.25 | 0.4 | 0.88 | 0.28 | 5.5 | 0.20 | 0.20 | 0.40 |

| | Wire composition (mass %) | | | | | |
|---|---|---|---|---|---|---|
| | | | | | Na compound (in | |
| | | B, B alloy, | | | terms of Na) + | |
| | | B oxide | | | K compound (in | (10*[C] + [Mn])/ |
| | ZrO₂ | (in terms of B) | Ti | Mg | terms of K) | ([Si] + [Mo] + [Cr]) |
| Example | 0 | 0.008 | 0.15 | 0.5 | 0.15 | 3.2 |
| | 0.01 | 0.020 | 0.20 | 0.3 | 0.20 | 5.6 |
| | 0 | 0.012 | 0.30 | 0.7 | 0.30 | 2.5 |
| | 0 | 0.001 | 0.05 | 0.2 | 0.01 | 3.8 |
| | 0 | 0.006 | 0.08 | 0.3 | 0.10 | 1.6 |
| | 0 | 0.010 | 0.25 | 0.7 | 0.20 | 3.1 |
| | 0 | 0.011 | 0.05 | 0.3 | 0.10 | 4.2 |
| | 0 | 0.001 | 0.05 | 0.2 | 0.01 | 5.9 |
| | 0 | 0.014 | 0.10 | 0.8 | 0.20 | 4.2 |
| | 0.10 | 0.000 | 0.10 | 0.6 | 0.10 | 0.9 |
| | 0 | 0.030 | 0.50 | 0.3 | 0.20 | 3.9 |
| | 0 | 0.010 | 0.00 | 0.2 | 0.00 | 2.0 |
| | 0.05 | 0.025 | 0.40 | 0.0 | 0.40 | 1.5 |

TABLE 2

| | | Wire composition (mass %) | | | | | | | | | | |
|---|---|---|---|---|---|---|---|---|---|---|---|---|
| | | | | | | | | | | | | Metal fluoride |
| | No. | Fe | C | Mn | Si | Cr | Ni | Mo | TiO₂ | SiO₂ | Al₂O₃ | (in terms of F) |
| Comparative | 14 | 75 | 0.06 | 1.5 | 0.20 | 0.1 | 0.75 | 0.30 | 21.0 | 0.25 | 0.05 | 0.10 |
| Example | 15 | 89 | 0 | 1.4 | 0.15 | 0.3 | 0.55 | 0.12 | 6.6 | 0.20 | 0.08 | 0.13 |
| | 16 | 90 | 0.10 | 0 | 0.26 | 0.5 | 0.60 | 0.15 | 7.2 | 0.31 | 0.14 | 0.08 |
| | 17 | 89 | 0.04 | 2.0 | 0 | 0.2 | 0.54 | 0.12 | 7.0 | 0.12 | 0.15 | 0.00 |
| | 18 | 88 | 0.04 | 1.4 | 0.06 | 0 | 0.93 | 0.12 | 8.7 | 0.08 | 0.03 | 0.18 |
| | 19 | 91 | 0.03 | 2.0 | 0.28 | 0.4 | 0 | 0.29 | 4.8 | 0.25 | 0.15 | 0.05 |
| | 20 | 89 | 0.15 | 3.0 | 0.34 | 0.2 | 0.90 | 0 | 5.0 | 0.14 | 0.07 | 0.50 |
| | 21 | 90 | 0.06 | 4.0 | 0.18 | 0.1 | 0.88 | 0.15 | 3.2 | 0.02 | 0.05 | 0.07 |
| | 22 | 88 | 0.06 | 2.1 | 0.40 | 0.3 | 0.64 | 0.26 | 7.4 | 0 | 0.10 | 0.08 |
| | 23 | 87 | 0.05 | 1.2 | 0.20 | 1.2 | 0.66 | 0.13 | 8.0 | 0.25 | 0 | 0.27 |
| | 24 | 90 | 0.05 | 1.4 | 0.13 | 0.4 | 1.30 | 0.20 | 5.3 | 0.15 | 0.10 | 0.18 |
| | 25 | 87 | 0.05 | 1.5 | 0.07 | 0.7 | 0.68 | 0.50 | 8.3 | 0.15 | 0.05 | 0.06 |
| | 26 | 85 | 0.07 | 2.0 | 0.07 | 0.1 | 0.68 | 0.40 | 10.4 | 0.06 | 0.09 | 0.08 |
| | 27 | 87 | 0.05 | 3.0 | 0.05 | 0.4 | 0.30 | 0.15 | 6.3 | 0.60 | 0.20 | 0.28 |
| | 28 | 87 | 0.10 | 1.8 | 0.25 | 0.5 | 0.90 | 0.20 | 7.5 | 0.06 | 0.50 | 0.30 |

| | Wire composition (mass %) | | | | | |
|---|---|---|---|---|---|---|
| | | | | | Na compound (in | |
| | | B, B alloy, | | | terms of Na) + | |
| | | B oxide | | | K compound (in | (10*[C] + [Mn])/ |
| | ZrO₂ | (in terms of B) | Ti | Mg | terms of K) | ([Si] + [Mo] + [Cr]) |
| Comparative | 0 | 0.013 | 0.20 | 0.3 | 0.04 | 3.6 |
| Example | 0 | 0.020 | 0.10 | 1.0 | 0.11 | 2.5 |
| | 0 | 0.004 | 0.09 | 0.3 | 0.05 | 1.1 |
| | 0 | 0.020 | 0.10 | 0.5 | 0.04 | 8.0 |
| | 0 | 0.003 | 0.10 | 0.1 | 0.05 | 10.0 |
| | 0 | 0.008 | 0.12 | 0.4 | 0.05 | 2.4 |
| | 0 | 0.003 | 0.16 | 0.3 | 0.05 | 8.3 |
| | 0 | 0.006 | 0.80 | 0.3 | 0.05 | 11.8 |
| | 0 | 0.012 | 0.12 | 0.3 | 0.07 | 2.8 |
| | 0.10 | 0.005 | 0.12 | 0.6 | 0.25 | 1.1 |
| | 0 | 0.012 | 0.16 | 0.4 | 0.00 | 2.6 |
| | 0 | 0.010 | 0.07 | 0.6 | 0.05 | 1.6 |
| | 0 | 0.019 | 0.14 | 0.7 | 0.01 | 5.1 |
| | 0 | 0.020 | 0.20 | 0.2 | 1.00 | 5.8 |
| | 0 | 0.000 | 0.13 | 0.5 | 0.05 | 2.9 |

Subsequently, the following tests for confirming properties were conducted with the flux-cored wires in Examples and Comparative Examples.

### <All-Weld Metal Welding>

A steel sheet, shown in Table 3 below was used as a base material. Gas-shielded arc welding was performed under conditions shown in Table 4 below to obtain a weld metal. The mechanical properties of the weld metal were measured by methods shown in Table 5 below. The balance of the composition of the base material shown in Table 3 below is Fe and incidental impurities. Regarding the mechanical properties, a weld metal having a 0.2% proof stress after SR at 620° C. for 8 hours of 500 MPa or more, a tensile strength of 600 MPa or more, and an absorbed energy at −40° C. of 70 J or more was evaluated as “Good”.

TABLE 3

| | | Base material composition (mass %) | | | | | | | | | |
|---|---|---|---|---|---|---|---|---|---|---|---|
| Steel type | Sheet thickness | C | Si | Mn | P | S | Ni | Cr | Mo | Ti | B |
| JIS G | 20 mm | 0.15 | 0.32 | 1.34 | 0.010 | 0.001 | 0.01 | 0.03 | — | — | — |
| 3106 | | | | | | | | | | | |

TABLE 4

| | |
|---|---|
| Groove shape | 20° V groove, Root gap = 16 mm, with backing strip |
| Shielding gas | 80% Ar-20% CO₂, Flow rate = 25 L/min |
| Welding position | Flat |
| Welding | Electric current: 260 to 300 A, Voltage: 28 to 32 V |
| conditions | Speed: 25 to 35 cm/min |
| | Welding heat input = 1.3 to 2.5 kJ/mm |
| Number of | 6 layers 12 passes |
| laminated layers | |
| Preheating and | 140 to 160° C. |
| interpass | |
| temperature | |
| Heat treatment | 620° C. × 8 hours |

TABLE 5

| | |
|---|---|
| Tensile test | JIS Z 3111 A2 test specimen, |
| | Sampling position = center of weld metal and center of |
| | thickness |
| | Test temperature: room temperature (20 to 23° C.) |
| Impact test | JIS Z 3111 V-notch test specimen |
| | Sampling position = center of weld metal and center of |
| | thickness |
| | Test temperature: −40° C. |

### <Hot Cracking Resistance>

The steel sheet shown in Table 3 above was used as a base material. A FISCO test (JIS Z 3155) was performed by gas-shielded arc welding under the conditions shown in Table 6 below to determine the cracking ratio of the obtained weld metal. The cracking ratio refers to a ratio (mass %) of the length of a crack (including a crater crack) to the length of the ruptured bead. Regarding the hot cracking resistance, a weld metal having a cracking ratio of 10 mass % or less was evaluated as “Good”.

TABLE 6

| Groove shape | 90° Y groove, Root face = 10 mm, Root |
|---|---|
| | gap = 2.4 mm |
| Shielding gas | 80% Ar-20% CO₂, Flow rate = 25 L/min |
| Welding position | Flat |
| Welding conditions | 280 A-31 V-35 cm/min |
| Number of laminated | 1 layer 1 pass |
| layers | |
| Preheating temperature | Room temperature (20 to 23° C.) |
| Number of repetitions | 2 |

### <Welding Workability>

The steel sheet shown in Table 3 above was used as a base material. Gas-shielded arc welding was performed under the conditions shown in Table 7 below to evaluate the welding workability. An evaluation result of “A” was given when the welding workability was excellent. An evaluation result of “B” was given when the welding workability was good. An evaluation result of “C” was given when the welding workability was poor.

TABLE 7

| | |
|---|---|
| Groove shape | T-type fillet welding |
| Shielding gas | 80% Ar-20% CO₂, Flow rate = 25 L/min |
| Welding position | (1) Horizontal fillet |
| | (2) Vertical up fillet |
| Welding conditions | (1) Horizontal fillet: 280 A-29 V-30 to 50 cm/min |
| | (2) Vertical up fillet: 210 A-23 V-10 to 15 cm/min |
| Number of | 1 layer 1 pass (both sides were welded) |
| laminated layers | |
| Preheating | Room temperature to 100° C. |
| temperature | |

Table 8 below collectively shows the evaluation results of the mechanical properties, welding workability, and cracking ratio of the weld metals (after SR) obtained using the flux-cored wires in Examples and Comparative Examples. The mechanical properties were also evaluated for weld metals in the as-welded condition, and all weld metals obtained by using the flux-cored wires in Examples had the desired values.

TABLE 8

| | | Mechanical properties (low-temperature | | | | | | |
|---|---|---|---|---|---|---|---|---|
| | | toughness, SR performance) | | | | | Hot cracking | |
| | | SR (620° C. × 8 hours) | | | Welding workability | | resistance | |
| | Wire | 0.2% proof stress | Tensile strength | vE (−40° C.) | | Amount of spatters | Cracking ratio | Overall |
| | No. | (MPa) | (MPa) | (J) | Bead shape | generated | (%) | evaluation |
| Example | 1 | 561 | 626 | 90 | A | A | 2 | A |
| | 2 | 549 | 639 | 78 | A | A | 5 | A |
| | 3 | 508 | 606 | 105 | A | A | 1 | A |
| | 4 | 576 | 648 | 86 | A | A | 2 | A |
| | 5 | 587 | 656 | 72 | A | A | 3 | A |
| | 6 | 520 | 612 | 110 | A | A | 3 | A |
| | 7 | 568 | 640 | 87 | A | A | 4 | A |
| | 8 | 540 | 628 | 71 | A | A | 2 | B |
| | 9 | 520 | 611 | 70 | A | B | 3 | B |
| | 10 | 504 | 615 | 73 | B | A | 1 | B |
| | 11 | 595 | 685 | 70 | A | A | 9 | B |
| | 12 | 592 | 687 | 75 | B | B | 6 | B |
| | 13 | 502 | 618 | 70 | B | B | 8 | B |
| Comparative | 14 | 560 | 648 | 61 | C | A | 5 | C |
| Example | 15 | 440 | 500 | 77 | B | B | 6 | C |
| | 16 | 490 | 550 | 52 | A | A | 2 | C |
| | 17 | 510 | 589 | 50 | C | B | 3 | C |
| | 18 | 500 | 570 | 35 | B | A | 7 | C |
| | 19 | 550 | 640 | 50 | A | A | 1 | C |
| | 20 | 460 | 556 | 43 | B | A | 1 | C |
| | 21 | 613 | 743 | 9 | C | B | 3 | C |
| | 22 | 559 | 643 | 38 | C | A | 1 | C |
| | 23 | 548 | 611 | 33 | C | B | 4 | C |
| | 24 | 511 | 632 | 95 | A | B | 30 | C |
| | 25 | 597 | 690 | 30 | A | A | 1 | C |
| | 26 | 550 | 624 | 54 | C | A | 3 | C |
| | 27 | 515 | 600 | 70 | B | C | 2 | C |
| | 28 | 541 | 634 | 88 | C | C | 3 | C |

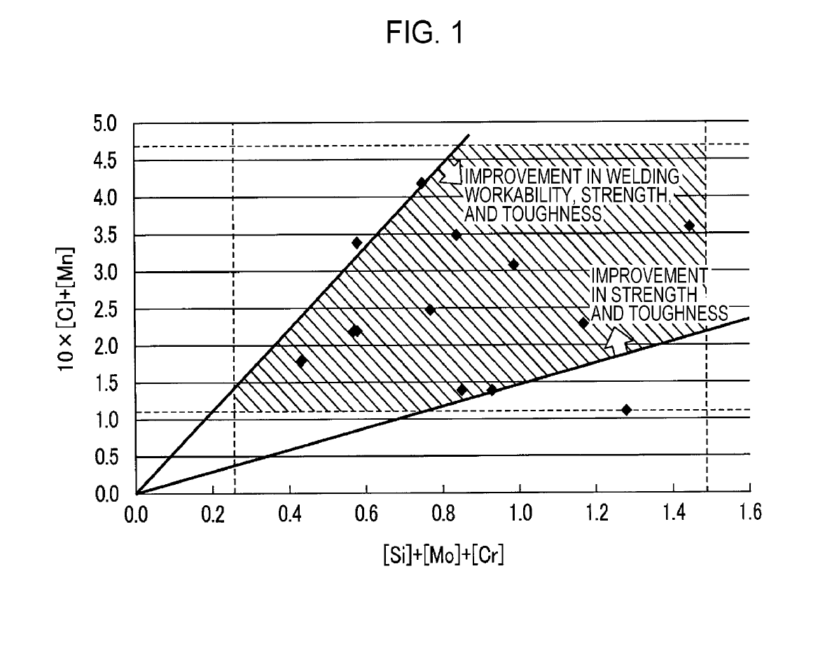

FIG. 1 illustrates an influence of the relationship between the C and Mn contents and the Si, Mo, and Cr contents in the flux-cored wire on the mechanical properties of weld metals. In FIG. 1, the results of Examples 1 to 13 are plotted. As specified in Claim 1, a value of [Si]+[Mo]+[Cr] is in the range of 0.25 to 1.5 and a value of 10×[C]+[Mn] is in the range of 1.1 to 4.7, and all the plots are positioned within the ranges (a region surrounded by a dotted line in FIG. 1). As illustrated in FIG. 1, when the relationship between the C, Mn, Si, Mo, and Cr contents, that is, (10×[C]+[Mn])/([Si]+[Mo]+[Cr]) is in the range of 1.6 to 5.6, the welding workability is better and the toughness and strength of the weld metal are higher than those in the case where the relationship is outside the range.

The foregoing results show that the present invention provides a flux-cored wire which achieves good welding workability and with which a weld metal having high low-temperature toughness is obtained in both the as-welded and heat-treated conditions even when the Ni content is 1 mass % or less.

The present invention has been described in detail with reference to a particular embodiment. However, it is obvious for those skilled in the art that various modifications and changes can be made without departing from the sprit and scope of the present invention.

The present application is based on Japanese Patent Application No. 2014-178915 filed on Sep. 3, 2014, the entire contents of which are incorporated herein by reference.

### INDUSTRIAL APPLICABILITY

The flux-cored wire for gas-shielded arc welding according to the present invention is suitable for welding of steels with a tensile strength of about 490 to 670 MPa, and is appropriate for, for example, transport equipment and facilities of petroleum and gas.

1. A flux-cored wire, the flux-cored wire being obtained by filling a steel sheath with a flux and comprising, relative to a total mass of the wire:
C: 0.01 to 0.12 mass %;
Si: 0.05 mass % or more and less than 0.30 mass %;
Mn: 1.0 to 3.5 mass %;
Ni: 0.1 mass % or more and less than 1.0 mass %;
Mo: 0.10 to 0.30 mass %;
Cr: 0.1 to 0.9 mass %;
TiO₂: 4.5 to 8.5 mass %;
SiO₂: 0.10 to 0.40 mass %;
Al₂O₃: 0.03 to 0.23 mass %; and
Fe: 80 mass % or more.

2. The flux-cored wire according to claim 1, wherein a V content is controlled to 0.020 mass % or less relative to the total mass of the wire.

3. The flux-cored wire according to claim 1, wherein a C content (mass %) [C], a Mn content (mass %) [Mn], a Si content (mass %) [Si], a Mo content (mass %) [Mo], and a Cr content (mass %) [Cr] relative to the total mass of the wire satisfy mathematical formula (A) below:
$$1.6 ≦ \frac{10 \times [ C ] + [ Mn ]}{[ Si ] + [ Mo ] + [ Cr ]} ≦ 5.6 . \qquad ( A )$$

4. The flux-cored wire for gas-shielded arc welding according to claim 1, further comprising at least one of (a) to (e) below:
(a) 0.2 to 0.7 mass % of Mg relative to the total mass of the wire,
(b) 0.05 to 0.30 mass % of Ti relative to the total mass of the wire,
(c) 0.05 to 0.30 mass % of a metal fluoride in terms of F relative to the total mass of the wire,
(d) 0.01 to 0.30 mass % in total of at least one of a Na compound and a K compound in terms of Na and K relative to the total mass of the wire, and
(e) 0.001 to 0.020 mass % in total of at least one of B, a B alloy, and a B oxide in terms of B relative to the total mass of the wire.

5. The flux-cored wire for gas-shielded arc welding according to claim 1, wherein a ZrO₂ content is controlled to less than 0.02 mass % relative to the total mass of the wire.
